(19) United States
(12) Patent Application Publication
(10) Pub. No.: US 2004/0097853 A1
(43) Pub. Date: May 20, 2004

(54) Support device for orthopedic rehabilitation

(76) Inventor: John Aidiniantz, Glendale, CA (US)

Correspondence Address: JOHN AIDINIANTZ, 806 NORTH KENILWORTH AVENUE, GLENDALE, CA, 91203, US

(21) Appl. No.: 10/299,319

(22) Filed: Nov. 19, 2002

(51) Int. Cl. A61H 15/00

(52) U.S. Cl. 601/115; 601/122

(57) ABSTRACT

A device whereby one or more nodules made from firm matter are configured or moved in such a way that when the said nodules are brought into contact with a human body, they correspond to, and are able to exert pressure on, the facet joints of the spine, using the weight of the said body and/or some conventional power source.

### CROSS-REFERENCE TO RELATED APPLICATIONS

N/A

### FEDERALLY SPONSORED RESEARCH

N/A

### SEQUENCE LISTING OR PROGRAM

N/A

### BACKGROUND OF THE INVENTION

1. Field of Invention

This invention relates to body support devices, specifically those designed to relieve spinal pain.

2. Prior Art

A number of devices have been made by entrepreneurs for the purpose of relieving spinal pain, but the devices are not based on medical principles and so do not solve the purpose for which they were intended.

In the field of art relating to body support devices, numerous devices have been made for the purpose of general massage, or for arching or stretching the spine, but no device has yet been invented for the specific purpose of applying pressure to spinal facet joints, although the benefits of applying pressure to such joints is understood in the field of orthopedic medicine.

Existing devices are designed merely to massage muscles or stretch or arch the spine with the intention of reducing back or neck pain, but they are unlikely to improve the user's condition and in fact these devices often make it much worse.

This is because invariably they do not act upon the spinal facet-joints, which are the major cause of most chronic spinal problems, but instead operate on the muscles of the body which are not the cause of spinal pain.

The spinal facet joints are located in pairs along either side of the spine from the neck to the base of the spine—one joint on each side.

The prior art contains no express or implied suggestion of the principle upon which the present invention rests, nor any modification that would fall within its ambit.

The probable reason why prior art inventors have not utilised the principle of decompressing the facet joints is because the principle is known only to those in the field of orthopaedic medicine—it is not common knowledge.

The advantage of the present invention over the prior art has not therefore been appreciated or even contemplated.

### OBJECTS AND ADVANTAGES

The object of the present invention is to provide a means of applying pressure to the spinal facet joints of the body.

The field of art to which the subject matter relates includes body support devices which apply pressure to the body via an external structure.

However, the specific principle that the invention utilises is found in the field of orthopedic medicine when an orthopedic consultant provides treatment for reducing back or neck pain by mobilising spinal joints using his hands.

The spinal facet joints are located in pairs along either side of the spine from the neck to the base of the spine—one joint on each side.

In this form of treatment, mobilisation of bone joints occurs when the practitioner moves joints by applying an external force manually, thereby restoring the ‘passive mobility’ of the joints that helps to reduce pain.

In the absence of treatment by a consultant the present invention achieves the same effect in relation to the facet joints of the spine by applying pressure to them.

This is achieved when the device comes into contact with user's body for a duration of time to allow the spinal facet joints to be ‘mobilised’ or moved. When this occurs the user should experience a reduction in spinal pain.

Whether the spinal facet joints are responsible for causing pain in any particular case would of course depend on all the facts, but in any event the sole purpose of the invention is to facilitate the application of pressure to the spinal facet joints.

The present invention is contrary to the teaching of prior art in that the device operates directly on the spine by applying pressure to the spinal facet joints and not to the muscles of the back.

### OBJECTS AND ADVANTAGES OF INVENTION Contd.

The invention would be unobvious to one skilled in the art of orthopedic medicine because a comprehensive knowledge of orthopedic treatment methods does not include or imply knowledge in the field of the present invention which relates to body support devices.

Furthermore, the invention can provide a means of treating multiple facet joints simultaneously, whereas normally an orthopaedic consultant would be capable of treating only one pair of facet joints at a time using both hands.

The invention would also be unobvious to one having ordinary skill in the art of making body support devices, because the specific knowledge of orthopaedic medicine relating to the ‘passive mobility’ of spinal joints is not common to this field of art.

Further objects and advantages will become apparent from a consideration of the ensuing description and drawing.

### SUMMARY

In accordance with the present invention, a device is utilised to press the facet joints of a person with the aim of reducing pain.

### DRAWINGS—FIGURES

FIG. 1 a basic configuration of the invention

FIG. 2 a preferred embodiment of the invention

FIG. 3 a section of the preferred embodiment

### WINGS—REFERENCE NUMERALS

10 nodule

11 spindle

12 the human spine

13 panel

### DETAILED DESCRIPTION OF INVENTION

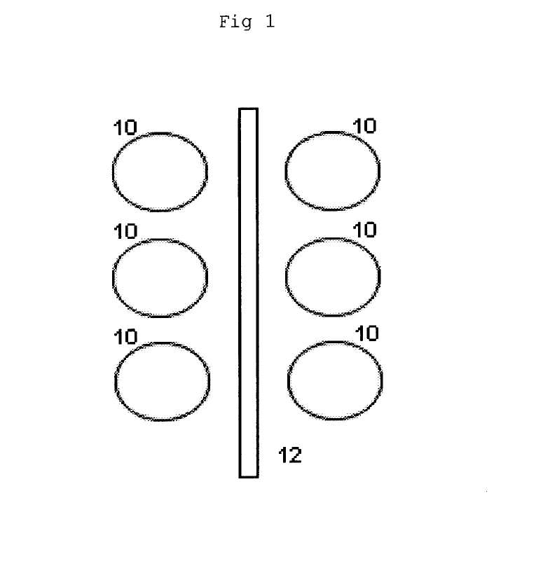

FIG. 1—The invention consists of one or more nodules 10 configured or moved in such a way that when the said nodules are brought into contact with a human body, pressure can be applied via the said nodules to the facet joints of the spine 12 using the weight of the said body or some conventional power source.

The said nodules can be made from any firm material such as wood, rubber, plastic, etc and can vary in size and shape. A preferred embodiment of a said nodule would look like a small chicken or quail's egg in shape and size.

In order to understand how the said nodules should be positioned in accordance with the invention, it would be useful to understand the position of the facet joints of the human spine.

The facet joints can be felt with the fingers as hard small lumps of bone the size and shape of a finger tip lying just beneath the surface of the flesh on either side of the spine.

The facet joints are spread out like links in a chain on two columns of bone that follow the length of the spine from the nape of the neck down to the posterior. The spine runs down the middle of the back between the two columns of facet joints.

Each facet joint on a column has a corresponding facet joint at the same level on the other column, thus making a pair.

Typically, the desired purpose of the invention is achieved if nodules are arranged in two rows on the basis that the centres of the spinal facet joints are 5 cm apart from each other along a column and 8 cm apart between columns.

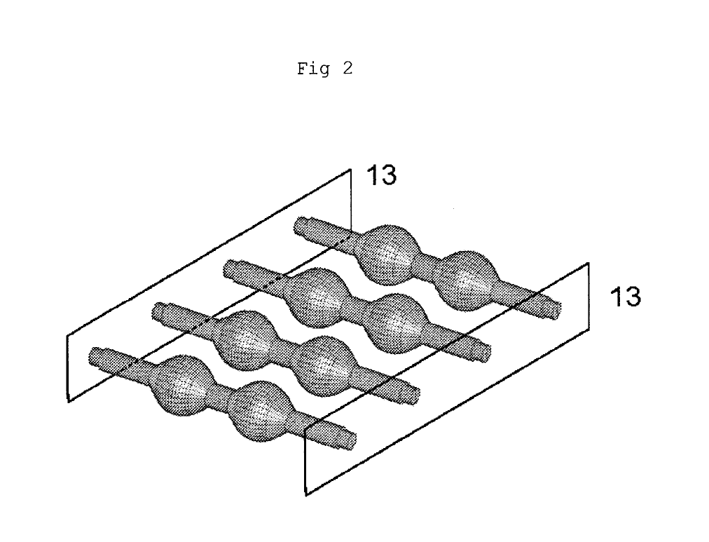

FIG. 2—This shows an example of a preferred embodiment made from wood where pairs of the said egg-shaped nodules are affixed to short spindles 11 that are held in place by two side panels. 13

Such an embodiment consists of 4 spindles and 8 egg-shaped nodules, each spindle being 23 cm in length and 2 cm in diameter and the gap

### DETAILED DESCRIPTION OF INVENTION Contd.

between each spindle being 3 cm. The ends of each spindle are affixed to a side panel and the dimensions of the two side panels in such an embodiment described would be about 6 cm high×2 cm thick×20 cm long.

The egg-shaped nodules in such an embodiment would be 4.5 cm in length and 5 cm wide and would be arranged with a gap of 2.5 cm between the nodules comprising a pair on a spindle. The spindles can be made to run through the middle of the nodules so that the nodules can rotate, or they can be fixed to the nodules in a static position as in the embodiment shown.

The embodiment shown is for illustration purposes only. A longer variation of the preferred embodiment might for example use 16 spindles and 32 nodules with longer side panels that could be shaped to follow the curve of a person's spine.

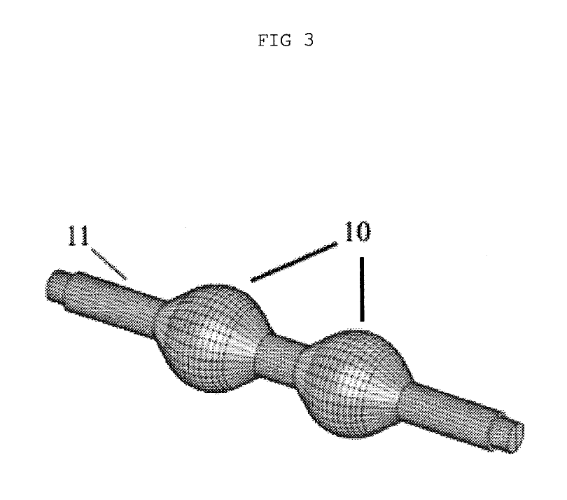

FIG. 3—This shows one of the spindles of the preferred embodiment with a pair of nodules.

### OPERATION

The manner of using the preferred embodiment shown is for the user to lie on the device which is placed on the floor, so that the nodules press on the facet joints.

### DESCRIPTION & OPERATION OF OTHER EMBODIMENTS

Many other variations are possible that might feature the basic principle of the invention which is to afford a means of applying pressure to the spinal facet joints by way of a device rather than the hands of an orthopedic practitioner.

For example, the invention could be incorporated in the form of a belt, a mattress, a cushion, a chair, or an automobile or airplane seat. It could also be fashioned as a portable/folding device for ease of transport.

The invention could be embodied to consist of different shapes and materials (fixed or moveable) that would be used for applying the required pressure on the facet joints. As an example, rotating rollers could be used instead of fixed nodules and the device could be made from various types of materials such as wood, plastic, or rubber etc.

In such cases the user would place the body against the nodules while in a sitting or standing position so that the nodules are aligned with and press on the spinal facet joints.

It is not necessary for a device incorporating the invention to press upon every facet joint some devices might be shorter than the preferred embodiment shown and hence may only press upon the facet joints of the neck or the lower back.

Alternatively, an embodiment might only contain one or two nodules which when moved up and down the spine will press upon some or all of the spinal facet joints. Thus, a single pair of nodules could be moved electronically or by some other means in order to pass over and press upon the facet joints either sequentially or randomly, and they could be made to apply a fixed or variable force with the assistance of some external conventional power source.

Thus it can be seen that the invention provides a convenient method of applying pressure to the spinal facet joints without the aid that is normally required of an orthopedic practitioner.

Many other variations of design can incorporate the invention which, as has already been stated, consists in applying pressure to the spinal facet joints via nodules which are specifically arranged or moved so as to allow pressure to be exerted on the facet joints of the human spine.

While the above descriptions contains many specific details, they should not be construed however as limitations on the scope of the invention, but rather as examples of embodiments which can vary in color, size, or material.

The scope of the invention should not therefore be limited by the embodiments described but by the appended claims and their legal equivalents.

I claim:

1. A device comprising several nodules of firm matter which are specifically configured or can be moved in such a way that when the said nodules make contact with a human body they correspond to the position of the facet joints of the human spine.

2. The device in claim 1 wherein the said nodules form part of a fixed structure.

3. The device in claim 1 wherein the said nodules form part of a moveable structure.

4. The device in claim 1 wherein the said nodules are egg-shaped.

5. The device in claim 1 wherein the said nodules are spherical.

6. The device in claim 1 wherein the said nodules are half-round.

7. The device in claim 1 wherein the said nodules are irregularly shaped.

8. The device in claim 1 wherein the said nodules are fashioned as rollers.

9. The device in claim 1 wherein the said nodules are fixed.

10. The device in claim 1 wherein the said nodules are moveable.

11. The device in claim 1 wherein it is adapted for use in or as a chair.

12. The device in claim 1 wherein it is adapted for use in or as a mattress.

13. The device in claim 1 wherein it is adapted for use in or as a belt.

14. The device in claim 1 wherein it is adapted for use in or as a cushion.

15. The device in claim 1 wherein it is adapted for use in or as a rigid frame.

16. The device in claim 1 wherein it is adapted for use in or as a folding frame.

17. The device in claim 1 wherein it is adapted for use for any part of the spine.

18. The device in claim 1 wherein pressure is applied to the spinal facet joints via the said nodules.

19. A method for applying pressure to the facet joints of the spine by:
a. ensuring that nodules made of firm matter are configured in a fixed or moveable way so that when they are brought into contact with a human body they correspond to the location of one or more spinal facet joints
b. exerting force via the said nodules to the facet joints by using the weight of the said body or some conventional power source, whereby the decompression of the facet joints in this way should bring relief and a reduction in spinal pain.
